(19) United States
(12) Patent Application Publication
(10) Pub. No.: US 2012/0073214 A1
(43) Pub. Date: Mar. 29, 2012

(54) Elevator Having a Modularized Framework

(76) Inventor: Yong-Long Sie, Yuanlin Township (TW)

(21) Appl. No.: 12/889,538

(22) Filed: Sep. 24, 2010

(51) Int. Cl. E04B 1/34; E04H 12/00; E04B 1/348; B66B 9/00

(52) U.S. Cl. 52/79.1; 52/653.1; 52/274

(57) ABSTRACT

An elevator includes a framework including a plurality of main posts, a plurality of wall units mounted between the main posts, and a plurality of transverse bars mounted between the main posts. A foundation is located at a bottom of the framework to support the framework. Thus, the elevator has a modularized framework which is assembled previously in the factory so that the workers can directly insert the framework into the passage of the building without having to assemble the framework at the site of the building, thereby enhancing the working efficiency, and thereby decreasing cost of construction.

### BACKGROUND OF THE INVENTION

1. Field of the Invention

The present invention relates to a transportation device and, more particularly, to an elevator to carry people up and down.

2. Description of the Related Art

A conventional elevator is mounted in a passage of a building to carry people up and down. The conventional elevator includes many parts that are assembled in the passage of the building. However, the workers have to deliver the parts of the elevator and the necessary tools into the passage of the building and have to assemble the elevator in the passage of the building, thereby decreasing the working efficiency, and thereby increasing the cost of construction.

### BRIEF SUMMARY OF THE INVENTION

In accordance with the present invention, there is provided an elevator, comprising a framework including a plurality of main posts, a plurality of wall units mounted between the main posts, and a plurality of transverse bars mounted between the main posts.

Each of the main posts of the framework has a bottom combined with a fixing seat. The fixing seat of each of the main posts has a surface formed with a plurality of fixing holes. The elevator further comprises a foundation located at a bottom of the framework to support the framework, a plurality of fastening bolts mounted on the foundation and extended through the fixing holes of the fixing seat of each of the main posts, and a plurality of fastening nuts screwed onto the fastening bolts and pressing the fixing seat of each of the main posts to lock the fixing seat of each of the main posts onto the foundation.

The framework has a rectangular cross-sectional profile and includes four main posts and four wall units. The main posts of the framework are disposed at four corners of the framework. Each of the wall units of the framework is located between and abuts any two adjacent main posts. At least one of the wall units of the framework has a surface formed with a plurality of openings each corresponding to one of a plurality of floors of a building. Each of the wall units of the framework consists a plurality of hollow steel bars which are juxtaposed to and combined with each other. Each of the steel bars of each of the wall units has a substantially C-shaped profile. Each of the steel bars of each of the wall units has a side formed with an elongate slot facing outward. The transverse bars of the framework are extended through each of the wall units to reinforce the strength of each of the wall units. Each of the transverse bars of the framework is extended through each of the steel bars of each of the wall units. The framework is inserted into a passage of a building. The framework has a top provided with at least one hanging ear. The framework has an inner portion formed with a receiving space to receive a cab, a plurality of counterweights, cables, an electricity control box and other appliances and parts. The foundation is located at a bottom of the passage of the building. The foundation has an inner portion formed with a mounting recess to partially receive the framework. The fastening bolts are mounted on a bottom face of the mounting recess of the foundation.

The primary objective of the present invention is to provide an elevator having a modularized framework.

According to the primary advantage of the present invention, the elevator has a modularized framework which is assembled previously in the factory so that the workers can directly insert the framework into the passage of the building without having to assemble the framework at the site of the building, thereby enhancing the working efficiency, and thereby decreasing the cost of construction.

According to another advantage of the present invention, the concrete is inserted into the elongate slot of each of the steel bars so that each of the wall units of the framework is combined with the concrete solidly and stably to enhance the structural stability of the framework.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially exploded perspective view of an elevator in accordance with the preferred embodiment of the present invention.

FIG. 2 is a perspective view showing the elevator is mounted on a building.

FIG. 3 is a perspective view showing the elevator is mounted on a foundation.

FIG. 4 is a partially front cross-sectional assembly view of the elevator as shown in FIG. 3.

FIG. 5 is a locally enlarged view of the elevator as shown in FIG. 4.

FIG. 6 is a top view of the elevator as shown in FIG. 4.

### DETAILED DESCRIPTION OF THE INVENTION

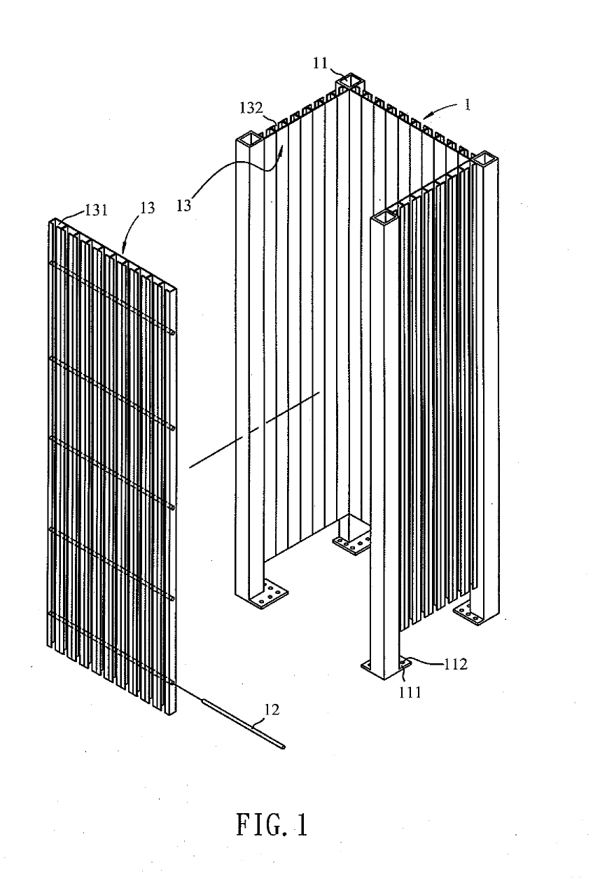

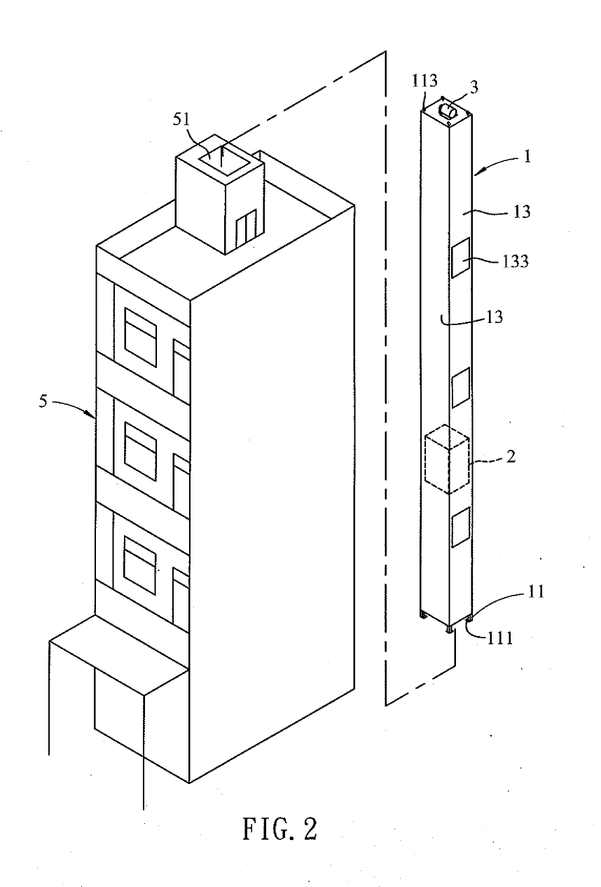

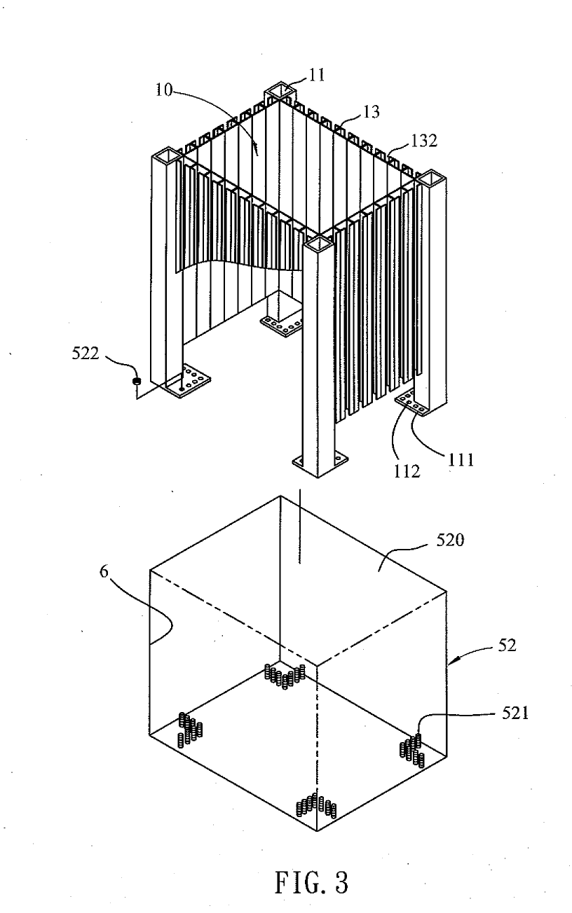

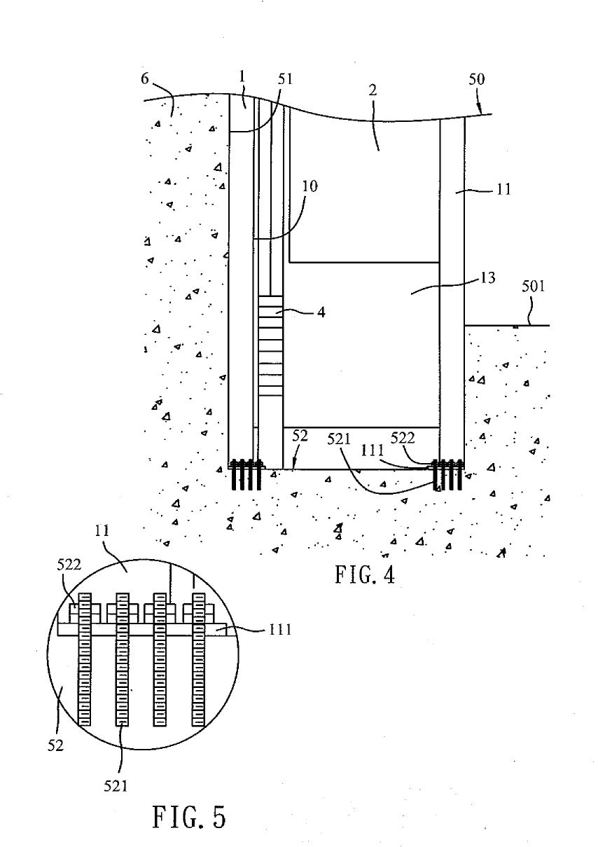

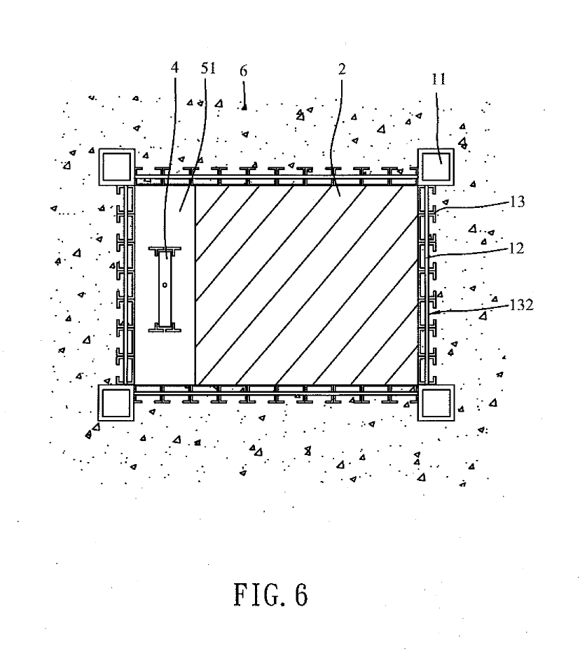

Referring to the drawings and initially to FIGS. 1-6, an elevator in accordance with the preferred embodiment of the present invention comprises a framework 1 and a foundation 52 located at a bottom of the framework 1 to support the framework 1.

The framework 1 is inserted into a passage 51 of a building 5. The framework 1 has a top provided with at least one hanging ear 113 and a drive motor 3. The framework 1 has an inner portion formed with a receiving space 10 to receive a cab 2, a plurality of counterweights 4, cables, an electricity control box and other appliances and parts.

The framework 1 includes a plurality of main posts 11, a plurality of wall units 13 mounted between the main posts 11, and a plurality of transverse bars 12 mounted between the main posts 11. In the preferred embodiment of the present invention, the framework 1 has a rectangular cross-sectional profile and includes four main posts 11 and four wall units 13.

The main posts 11 of the framework 1 are disposed at four corners of the framework 1. Each of the main posts 11 of the framework 1 is a steel bar that is made by casting or rolling. Each of the main posts 11 of the framework 1 has a rectangular cross-sectional profile and has a length of about twelve to thirteen meters (12-13 m).

Each of the main posts 11 of the framework 1 has a bottom combined with a fixing seat 111 by soldering. The fixing seat 111 of each of the main posts 11 has a surface formed with a plurality of fixing holes 112, and the elevator further comprises a plurality of fastening bolts 521 mounted on the foundation 52 and extended through the fixing holes 112 of the fixing seat 111 of each of the main posts 11, and a plurality of fastening nuts 522 screwed onto the fastening bolts 521 and pressing the fixing seat 111 of each of the main posts 11 to lock the fixing seat 111 of each of the main posts 11 onto the foundation 52.

Each of the wall units 13 of the framework 1 has a length smaller than that of each of the main posts 11. Each of the wall units 13 of the framework 1 is located between and abuts any two adjacent main posts 11 by soldering, and any two adjacent wall units 13 of the framework 1 abut each other. Each of the wall units 13 of the framework 1 is combined with a plurality of transverse bars 12. At least one of the wall units 13 of the framework 1 has a surface formed with a plurality of openings 133 each corresponding to one of a plurality of floors of the building 5. Each of the wall units 13 of the framework 1 consists a plurality of hollow steel bars 131 which are juxtaposed to each other and are combined by soldering. Each of the steel bars 131 of each of the wall units 13 has a substantially C-shaped profile and has a side formed with an elongate slot 132 facing outward.

Each of the transverse bars 12 of the framework 1 is located between any two adjacent main posts 11. The transverse bars 12 of the framework 1 are parallel with each other and are extended through each of the wall units 13 to reinforce the strength of each of the wall units 13. Each of the transverse bars 12 of the framework 1 is perpendicular to each of the wall units 13 and is extended through each of the steel bars 131 of each of the wall units 13.

The foundation 52 is located at a bottom of the passage 51 of the building 5 and has an inner portion formed with a mounting recess 520 to partially receive the framework 1. The mounting recess 520 of the foundation 52 is located at the ground 501 of the first floor 50 of the building 5 and has a depth of about one to one point five thirteen meters (1-1.5 m). The fastening bolts 521 are mounted on a bottom face of the mounting recess 520 of the foundation 52.

In assembly, the framework 1 is assembled previously in the factory. At this time, the cab 2, the drive motor 3, the counterweights 4, the cables, the electricity control box and other appliances and parts are received in the receiving space 10 of the framework 1. Then, the framework 1 is transported to the building 5. Then, the hanging ear 113 of the framework 1 is hung by a truck crane so that the framework 1 is inserted into the passage 51 of the building 5. When the framework 1 is inserted into the mounting recess 520 of the foundation 52, the fixing holes 112 of the fixing seat 111 of each of the main posts 11 are aligned with and mounted on the fastening bolts 521. Then, the framework 1 is plumbed to calibrate the verticality of the framework 1. Then, the fastening nuts 522 are screwed onto the fastening bolts 521 and press the fixing seat 111 of each of the main posts 11 to lock the fixing seat 111 of each of the main posts 11 onto the foundation 52 so as to lock the framework 1 onto the foundation 52. Then, concrete 6 is grouted into the passage 51 of the building 5 to surround the framework 1 so as to fix the framework 1 in the passage 51 of the building 5. At this time, the wall units 13 of the framework 1 stop the concrete 6 to prevent the concrete 6 from entering the receiving space 10 of the framework 1. In such a manner, the concrete 6 is inserted into the elongate slot 132 of each of the steel bars 131 so that each of the wall units 13 of the framework 1 is combined with the concrete 6 solidly and stably to enhance the structural stability of the framework 1. In addition, the electric appliances in the framework 1 has to be waterproofed so as to prevent the electric appliances from being wetted. In addition, a pump is placed in the foundation 52 to pump and carry away the water in the foundation 52.

Accordingly, the elevator has a modularized framework 1 which is assembled previously in the factory so that the workers can directly insert the framework 1 into the passage 51 of the building 5 without having to assemble the framework 1 at the site of the building 5, thereby enhancing the working efficiency, and thereby decreasing the cost of construction. In addition, the concrete 6 is inserted into the elongate slot 132 of each of the steel bars 131 so that each of the wall units 13 of the framework 1 is combined with the concrete 6 solidly and stably to enhance the structural stability of the framework 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. An elevator, comprising:
a framework including:
a plurality of main posts;
a plurality of wall units mounted between the main posts; and
a plurality of transverse bars mounted between the main posts.

2. The elevator of claim 1, wherein
each of the main posts of the framework has a bottom combined with a fixing seat;
the fixing seat of each of the main posts has a surface formed with a plurality of fixing holes;
the elevator further comprises:
a foundation located at a bottom of the framework to support the framework;
a plurality of fastening bolts mounted on the foundation and extended through the fixing holes of the fixing seat of each of the main posts; and
a plurality of fastening nuts screwed onto the fastening bolts and pressing the fixing seat of each of the main posts to lock the fixing seat of each of the main posts onto the foundation.

3. The elevator of claim 1, wherein
the framework has a rectangular cross-sectional profile and includes four main posts and four wall units;
the main posts of the framework are disposed at four corners of the framework;
each of the wall units of the framework is located between and abuts any two adjacent main posts.

4. The elevator of claim 1, wherein at least one of the wall units of the framework has a surface formed with a plurality of openings each corresponding to one of a plurality of floors of a building.

5. The elevator of claim 1, wherein each of the wall units of the framework consists a plurality of hollow steel bars which are juxtaposed to and combined with each other.

6. The elevator of claim 5, wherein each of the steel bars of each of the wall units has a substantially C-shaped profile.

7. The elevator of claim 5, wherein each of the steel bars of each of the wall units has a side formed with an elongate slot facing outward.

8. The elevator of claim 1, wherein the transverse bars of the framework are extended through each of the wall units.

9. The elevator of claim 5, wherein each of the transverse bars of the framework is extended through each of the steel bars of each of the wall units.

10. The elevator of claim 2, wherein the framework is inserted into a passage of a building.

11. The elevator of claim 1, wherein the framework has a top provided with at least one hanging ear.

12. The elevator of claim 1, wherein the framework has an inner portion formed with a receiving space.

13. The elevator of claim 10, wherein
the foundation is located at a bottom of the passage of the building;
the foundation has an inner portion formed with a mounting recess to partially receive the framework;
the fastening bolts are mounted on a bottom face of the mounting recess of the foundation.

14. The elevator of claim 1, wherein each of the main posts of the framework has a rectangular cross-sectional profile.

15. The elevator of claim 1, wherein each of the wall units of the framework has a length smaller than that of each of the main posts.

16. The elevator of claim 1, wherein the any two adjacent wall units of the framework abut each other.

17. The elevator of claim 1, wherein each of the wall units of the framework is combined with a plurality of transverse bars.

18. The elevator of claim 1, wherein each of the transverse bars of the framework is located between any two adjacent main posts.

19. The elevator of claim 1, wherein the transverse bars of the framework are parallel with each other.

20. The elevator of claim 1, wherein each of the transverse bars of the framework is perpendicular to each of the wall units.
